(19) United States
(12) Patent Application Publication
(10) Pub. No.: US 2005/0036408 A1
(43) Pub. Date: Feb. 17, 2005

(54) Automated storage library cartridge gripper with cartridge detector

(75) Inventors: Peter Dickey, Costa Mesa, CA (US); Raoul Standt, Newport Beach, CA (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 10/642,038

(22) Filed: Aug. 15, 2003

(51) Int. Cl. G11B 7/085

(52) U.S. Cl. 369/30.36

(57) ABSTRACT

In one exemplary embodiment a mechanical gripper mechanism for transporting storage devices and having a cartridge detector is provided. The gripper includes a pair of opposing gripper fingers, where each gripper finger includes a proximal end pivotally mounted to the picker frame, and a distal end adapted to engage minor side surfaces of a storage device. Further, the gripper mechanism includes a cartridge detector extending away from the picker frame and at least partially depressible between the pair of opposing gripper fingers. The distal end of the cartridge detector has a larger cross-sectional area than the proximal end of the cartridge detector.

### CROSS-REFERENCE TO RELATED APPLICATIONS

The present application is related to co-pending U.S. patent application Ser. No. ______ [attorney docket no. 249212021200], entitled “AUTOMATED STORAGE LIBRARY GRIPPER APPARATUS AND METHOD,” filed on Aug. 15, 2003, and U.S. patent application Ser. No. ______ [attorney docket no. 249212025900], entitled “AUTOMATED STORAGE LIBRARY GRIPPER WITH FINGER POSITION DETECTOR,” filed on Aug. 15, 2003, both of which are hereby incorporated by reference herein in their entirety.

### BACKGROUND OF THE INVENTION

1. Field of the Invention

The present invention relates generally to automated storage library gripper mechanisms, and more particularly to gripper mechanisms and methods for detecting and handling storage cartridges, e.g., magnetic tape cartridges, in automated storage libraries.

2. Description of the Related Art

Magnetic tape cartridges have proven to be an efficient and effective medium for data storage in computer systems. Large computer systems may utilize numerous cartridges for data storage purposes as well as a plurality of tape drives for inputting and outputting data to and from storage cartridges in a timely manner. Typically, as the number of storage cartridges grows they are organized in automated storage libraries. Automated storage libraries including magnetic tape cartridges may improve access speed and reliability of data storage systems having large numbers of magnetic tape cartridges.

Automated cartridge libraries generally include a plurality of storage bins or slots for storing library tape cartridges, a robotic cartridge gripping mechanism (often referred to as a “picker”), and one or more tape drives. The robotic picker may be controlled to select a specific storage tape cartridge from the library and transfer the tape cartridge between a storage slot and a tape drive within seconds. The robotic picker typically includes a gripper or hand mechanism positioned on the robotic picker. The robotic picker may position the gripper near a desired tape cartridge and activate the gripper to engage or grip the tape cartridge to remove the cartridge from the storage bin. The robotic arm may move the gripper and tape cartridge to a location to load the tape cartridge into a tape drive, load port (for adding or removing tapes from the library), and the like.

The storage cartridges are typically arranged in storage slots stacked within a cabinet or housing of the automated storage library. To quickly locate and retrieve a cartridge from the library an inventory of the storage cartridges located within the storage library system is performed, typically after loading cartridges into the library system. Each cartridge may include a label, such as a barcode label, that may be read by a bar code scanner mechanically coupled to the picker mechanism. The bar code scanner generally includes a laser that scans across the barcode label surface. The bar code label may be used to identify the cartridge, e.g., the stored data if any on that particular cartridge. Additional sensors may also be included to determine empty storage slots.

In addition to the identity of a cartridge, the physical location of each cartridge is desirable known at the time of picking or engaging the cartridge. Various storage bin locations within a library cabinet may vary by an inch or more depending on the particular system. For example, a cabinet wall may be warped slightly such that the location and opening of storage bins along the cabinet wall are located at different distances from the gripper mechanism. Variations in the locations may result in cartridges being located at different distances from the gripper during a picking process. Further, tape cartridges have clearance between themselves and the storage bins that may vary within a library cabinet. Thus, the actual physical location of each storage cartridge within a storage bin is desirably determined during the actual pick.

One process for determining the actual physical location of a cartridge includes non-contact sensors, for example, optical or acoustic sensors, that may determine the location of the storage cartridge. Such sensors however add considerable cost and complexity to the system. Alternatively, force feedback may be used to determine the location of the storage cartridge, for example, by moving the gripper towards a storage cartridge until resistance is found. A spike in current to the motor moving the gripper may indicate the location of the cartridge.

Further, to increase storage capacity within a storage library the storage cartridges are generally disposed or positioned with high density within the library. The density at which the cartridges may be packed relies, at least in part, on the size and configuration of the gripper mechanism. Typically, a gripper mechanism engages a cartridge from the top and bottom major surface of the cartridge. This method may dictate that storage slots be separated by a sufficient distance or clearance for the gripper mechanisms to fit between adjacent cartridges and storage bins during a pick. The separation between storage slots results in lower cartridge packing density within the library.

Therefore, what is needed is a system and method for providing feedback to the gripper positioning control system indicating that the gripper mechanism is in a suitable position to pick the cartridge from a storage bin or drive. Further, a system and method for sensing a suitable position of the cartridge with respect to the gripper mechanism at reduced cost and complexity to the library system are needed.

### BRIEF SUMMARY OF THE INVENTION

In one exemplary embodiment a mechanical gripper mechanism for transporting storage devices and having a cartridge detector is provided. The gripper includes a pair of opposing gripper fingers, where each gripper finger includes a proximal end pivotally mounted to the picker frame, and a distal end adapted to engage the minor side surfaces of a storage device, e.g., a magnetic tape cartridge. Further, the gripper includes a cartridge detector extending away from the picker frame and at least partially depressible between the pair of opposing gripper fingers. The distal end of the cartridge detector has a larger cross-sectional area measured perpendicular to the direction the cartridge detector extends than the proximal end of the cartridge detector. The cartridge detector is configured to engage a cartridge and move relative to the picker frame indicating a position of the cartridge.

In another exemplary embodiment an assembly for detecting storage cartridges for a mechanical gripper device is provided. The assembly includes a support structure for supporting a proximal end of the cartridge detector, where the cartridge detector extends away from the support structure. The support structure allows the cartridge detector to move in a substantially linear motion. The distal end of the cartridge detector has a larger cross-sectional area measured perpendicular to the direction the cartridge detector extends than the proximal end of the cartridge detector. The device further includes a sensor configured to detect indicia on the cartridge detector indicating the cartridge detector has moved a predetermined distance relative to the support structure.

The present invention and its various embodiments are better understood upon consideration of the detailed description below in conjunction with the accompanying drawings and claims.

### BRIEF DESCRIPTION OF THE DRAWINGS

FIG. 1 illustrates an exemplary automated storage library system;

FIG. 2 illustrates an exemplary gripper assembly adjacent a column of storage slots;

FIGS. 3A-3C illustrate an exemplary gripper assembly having a cartridge detector in a closed position, open position, and engaging a cartridge respectively;

FIGS. 4A-4B illustrate an exemplary cartridge detector having interconnected gripper fingers and a cartridge detector in more detail; and

FIG. 5 illustrates an exemplary cartridge detector assembly including an optical sensor.

### DETAILED DESCRIPTION OF THE INVENTION

The following description is presented to enable any person skilled in the art to make and use the invention. Descriptions of specific materials, techniques, and applications are provided only as examples. Various modifications to the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the scope consistent with the appended claims.

In one example, a gripper mechanism is provided having a cartridge detector, e.g., a plunger device, configured to provide feedback to a controller indicating that the gripper is in a suitable position to engage or pick a storage device from a storage bin or media drive. The gripper mechanism may include two opposing gripper fingers having a proximal end pivotally mounted to the picker frame and a distal end adapted to engage the minor side surfaces of a storage cartridge. The cartridge detector extends away from the picker frame and depresses, at least partially, between the pair of opposing gripper fingers. The cartridge detector further has a distal end with a larger cross-sectional area than the proximal end, e.g., a plate or relatively large surface, to engage the opposing surface or front face of the storage cartridge. The large distal of the cartridge detector improves, among other things, the detection of various sized and shaped storage cartridges with reduced erroneous determinations of the cartridge position. Further, gripping storage cartridges by their minor side surfaces allows for increased packing density and storage capacity of a given storage library as the clearance between adjacent cartridges may be reduced.

The examples described herein are generally described as a magnetic tape library including multiple magnetic tape cartridges. It should be understood, however, that the various embodiments are contemplated with use for other types of storage media and storage media libraries. For example, a storage library may include optical media devices alone or in combination with magnetic media storage devices and the like.

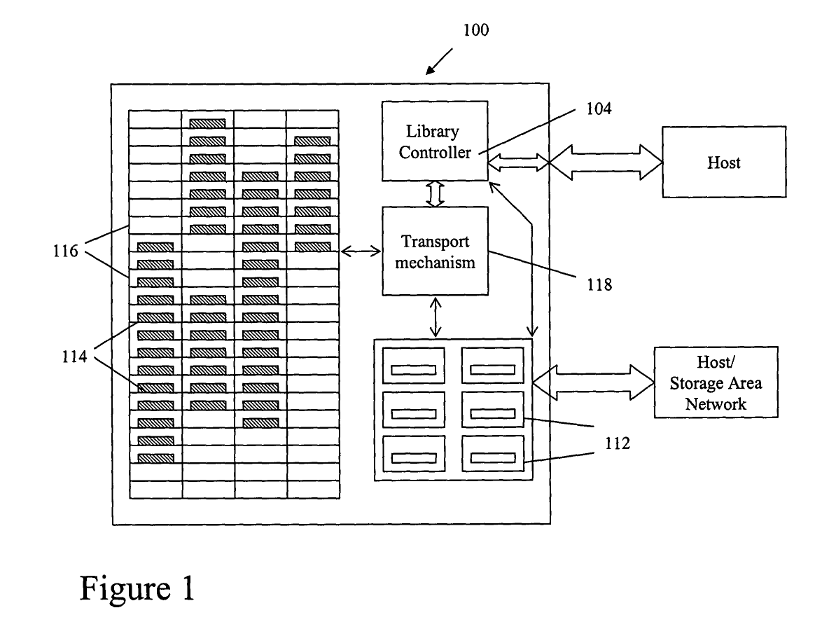

FIG. 1 is a schematic illustration of an exemplary automated storage library system 100 for the storage and retrieval of a plurality of storage cartridges 114 stored therein. Library system 100 includes one or more media drives 112, a plurality of storage tapes or cartridges 114 stored in bins or storage slots 116, and a transport mechanism 118 that may be equipped with a picker mechanism (not shown) for transporting a selected cartridge 114, for example, between a drive 112 and a storage slot 116. Storage library system further includes a library controller 104 that communicates with a host processor or computer network to control the actions of transport mechanism 118 and drives 112 to retrieve and/or store data.

Library controller 104 may include a single general purpose computer, microprocessor, microcontroller, and the like. Alternatively, a separate cartridge loader controller and a library system controller may be included. A general library controller 104, tape cartridge loader controller, or library controller may include any programmable general purpose computer or processor and preferably will have a suitably programmed microprocessor or microcontroller. The input-output connections between the library controller and various other components of the library system 100 may include well-known industry standard cabling and communication protocols. For example, Ethernet, Inter-Integrated Circuit bus (12C), Small Computer System Interface (SCSI), ultra-wide SCSI, fast SCSI, fibre channel, and the like.

Library controller 104 operates to coordinate movements and actions of media drives 112, robotic transport mechanism 118, and the like. The controller 104 may include a suitable processor as described above and is typically interconnected with a host processor, which sends access commands to controller 104. In this example, information recorded to or read from one or more of the cartridges 114 is transmitted between one of the drives 112 to the host or a storage area network through a second data path connection, e.g., a fibre channel bridge or the like.

Media drives 112 may include, for example, magnetic tape drives and/or optical disk drives, and cartridges 114 may include, for example, magnetic and/or optical storage devices. An exemplary drive includes the SDLT™ 320 magnetic tape drive, and an exemplary storage cartridge includes the Super DLTape™ Type I storage cartridge both sold by Quantum Corporation. It should be understood, however, that other magnetic tape storage devices and drives may be used.

Automated storage library system 100 may further include various other features such as load ports for manually adding and removing cartridges to and from the library, various access doors, control panels, power supplies, and the like as are known in the art. For clarity, however, such additional features have been omitted from the description.

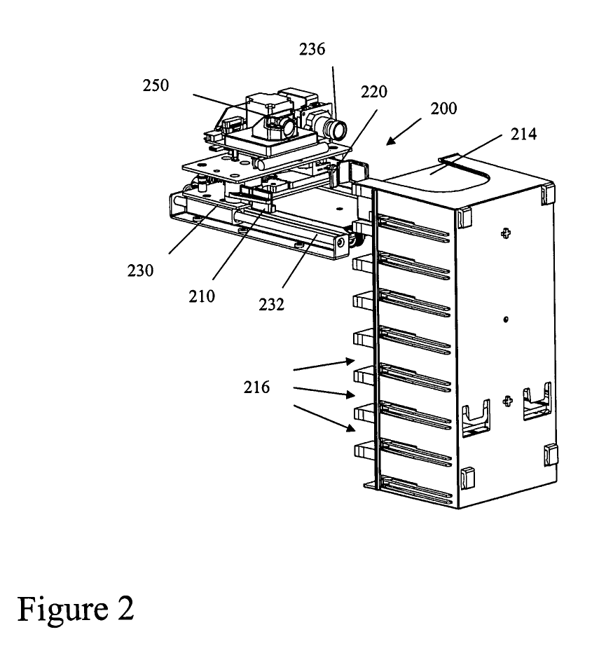

FIG. 2 illustrates a detailed view of an exemplary robotic transport mechanism having a gripper assembly 200 adjacent a column of storage slots 216 including cartridge 214. A storage library may include any number of storage slots 216 arranged in various manners. For example, storage slots 216 may be angled down from a front opening to the back to more securely hold cartridges 214. One or more columns of storage slots 216 may be arranged along an interior cabinet of a library system that has flat or curved interior surfaces.

Gripper fingers 210 are attached to a picker frame 230 that may translate along a platform 232 towards cartridge 214. As gripper assembly 200 approaches a cartridge 214, gripper fingers 210 are in an open position such that cartridge 214 may fit between gripper fingers 210. Cartridge detector 220 will contact the opposing face of cartridge 214 and depress or move linearly relative to gripper fingers 210 and picker frame 230. In this example, cartridge detector 220 serves as a plunger with a large distal end configured to engage and be resilient against tape cartridge 214. Depressing cartridge detector 220 indicates to a controller, e.g., a system controller or gripper controller, the position of cartridge 214 relative to gripper fingers 210 and more generally gripper assembly 200. Cartridge detector may include several trip points, e.g., indicating a cartridge is approaching and a stop point where cartridge 214 is in suitable position for gripper fingers 210 to engage cartridge 214.

In this example, gripper fingers 210 are arranged to engage the minor side surface of cartridge 214, rather than the major (top and bottom) surfaces of cartridge 214. This allows for cartridges to be stacked more densely within a storage library system because clearance above and below each cartridge may be reduced compared to conventional grippers that engage the major surfaces of cartridge 214.

Gripper assembly 200 may further have various features known in the art such as a barcode scanner 250 and calibration camera 236. Barcode scanner may be used to read a barcode label affixed to cartridge 214 and calibration camera may be used to determine and store the location of each storage bin 216 relative to gripper assembly 200. Additionally, further mechanisms such as pulleys, motors, and the like for vertical and horizontal translation may be included to move gripper assembly 220 within the storage library system.

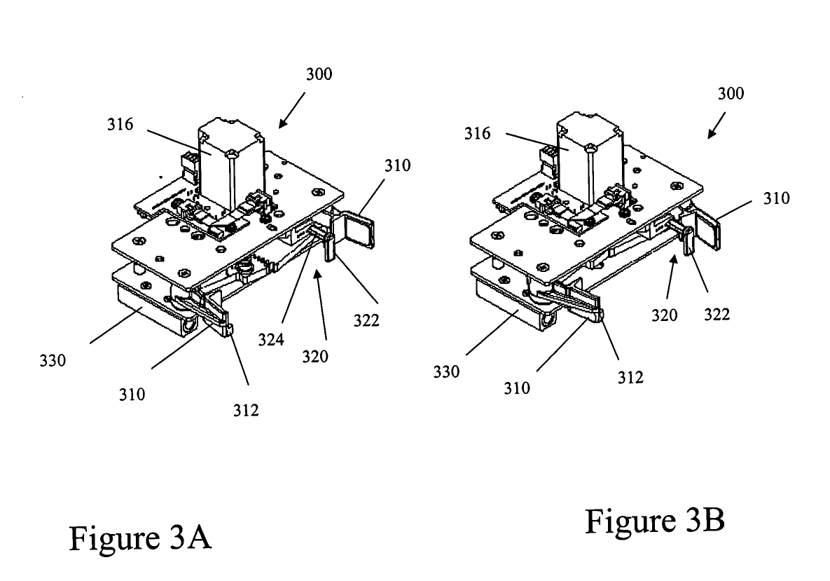

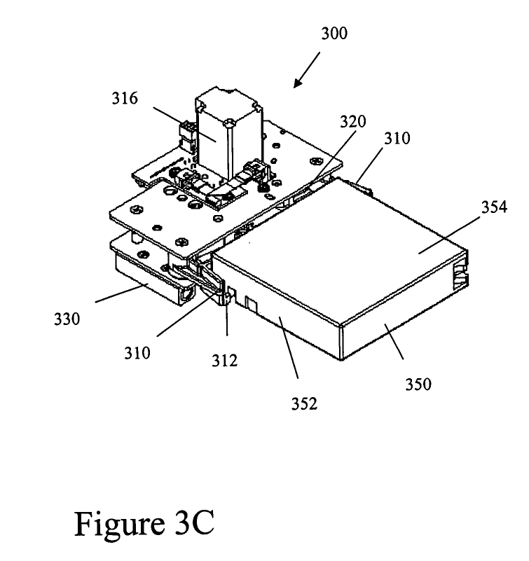

FIGS. 3A, 3B, and 3C illustrate an exemplary gripper assembly 300 having a cartridge detector in an open position, closed position, and engaging a storage cartridge 354 respectively. As seen in FIG. 3A, gripper 300 includes opposing gripper fingers 310 pivotally attached to a frame 330 and a cartridge detector 320 having a large distal end 322 extending from a more narrow proximal end 324. With gripper 300 in the open position to receive or release a storage cartridge, cartridge detector 320 extends away from the base or frame 330 of gripper assembly 300.

Cartridge detector 320 includes a broad distal end 322 with a relatively larger cross-sectional area than the proximal end 324 when measured perpendicular to the direction in which cartridge detector 320 extends away from frame 330. The broad distal end 322 allows for cartridge detector 320 to interact and detect cartridges of various sizes and profiles. For example, a smaller distal end such as a pin or deflecting lever may miss a cartridge or provide erroneous detections based on the profile of the facing surface of a cartridge. Distal end 322 may have various cross-sectional shapes such rectangular, circular, oval, cross-hair, and the like. The smaller proximal end 324 allows, for example, a lower profile of gripper mechanism 300 and gripper fingers 320 to interact during operation. Further, the proximal end may be out of plane with gripper fingers 310 allowing for additional design configurations of gripper mechanism 300.

Cartridge detector 320 may extend various distances from gripper mechanism 300. In this example, the distal end 322 is located between gripper fingers 310, i.e., the distal end does not extend beyond gripper fingers 310. Alternatively, cartridge detector 320 may extend to a distance equal to or beyond gripper fingers 310 such that a cartridge may be detected prior to entering between gripper fingers 310. Thus, distal end 322 depresses or moves at least partially between gripper fingers 310 as a cartridge is received between gripper fingers 310. Further, distal end 322 is shown as approximately as thick or wide in the vertical direction as the cartridge and gripper fingers 310. Distal end 322 may be made larger or smaller than gripper fingers 310 in this respect depending on the particular application, expected storage cartridge profiles, and the like.

In one example, distal end 322 may be removable such that different sized or shaped ends may be included with cartridge detector 320. Further, extensions of different lengths may be added to extend cartridge detector 320 to various distances. Alternatively, cartridge detector 320, including distal end 320, may be fixed as a single integral piece or attached in a non-removable manner.

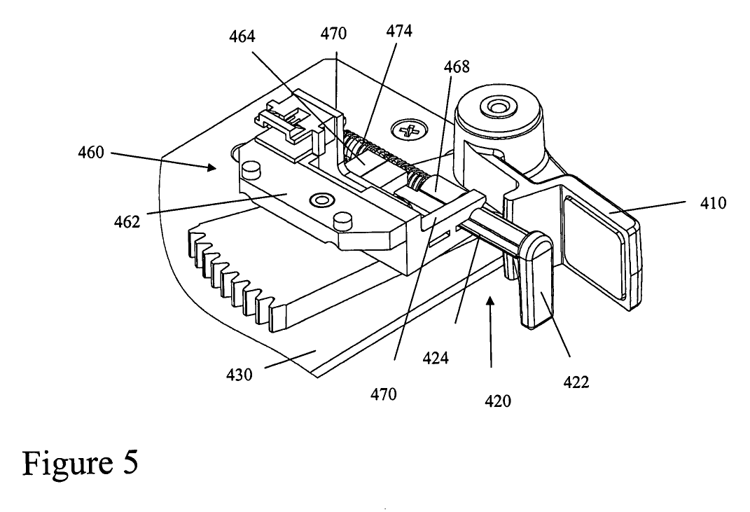

FIGS. 3B and 3C illustrate the exemplary gripper assembly 300 in the closed position with and without a cartridge 350 held between gripper fingers 310. As gripper assembly 300 approaches cartridge 350 the distal end 322 of plunger 320 contacts the opposing or front face of cartridge 350. Cartridge detector 320 depresses linearly and indicates to a gripper assembly controller when cartridge 350 is in a suitable position to close gripper fingers 312. For example, the position of plunger 320 may be monitored with sensors, e.g., optical sensors (See FIG. 5), to determine the distance from the front surface of cartridge 350. With cartridge 350 in a suitable position, gripper fingers 312 move to engage the edges or the minor side surfaces 352 (as opposed to the major surface 354) of cartridge 350. Alternatively, gripper fingers may be configured to grip the major surfaces 354 of cartridge 350.

Preferably, gripper fingers 310 are pivotally attached to frame 330 such that distal ends thereof open and close to secure a tape cartridge 350 by engaging the housing on the minor side surfaces 352. One of the gripper fingers may further include a protrusion 312 to engage a corresponding notch or groove included in tape cartridge 350. Gripping a cartridge 350 by its minor side surface 352 or its shortest dimension may reduce space lost to allow a gripper mechanism access when picking a cartridge. For example, a gripper mechanism that grips a cartridge by the top and bottom surface will generally need clearance above and below the cartridge to move in above and below cartridge 350, thereby decreasing the packing density of cartridges within the storage library.

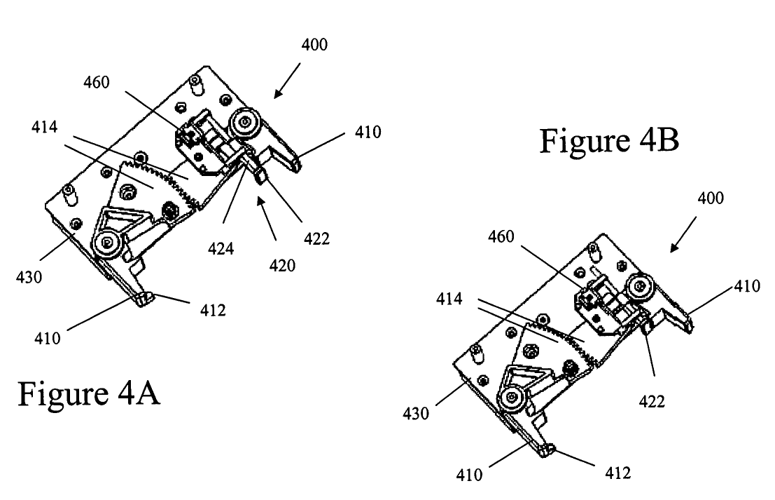

Gripper fingers 310 are interconnected to a single actuator 316. The proximal end of gripper fingers 310 may rotate and interact through a toothed or geared portion (seen more clearly in FIGS. 4A, 4B). Actuator 316 rotates at least one of the gripper fingers 310 such that gripper fingers 310 rotate open or closed together through the geared portion. The gripper fingers 310 are preferably motor driven open and spring loaded or biased closed. This allows for a loss of system power, anticipated or unanticipated, while gripper fingers 310 hold a cartridge with the force provided by springs or the like coupled to gripper fingers 310. Further, the cartridge may be manually removed without restoring power to the library system. In contrast, conventional gripper mechanisms often include a lead screw operable to open and close gripper fingers; however, such devices generally do not allow for manually opening the gripping fingers in the absence of power and are slow moving.

Although the gripper mechanism has been described as gripping from the side surfaces of a storage cartridge, it should be understood that various other gripper mechanisms are possible for gripping a storage cartridge in conjunction with the exemplary cartridge detector. For example, cartridge detector may be used in conjunction with a traditional gripper mechanism that grips a cartridge on the major surfaces, i.e., top and bottom surfaces.

FIGS. 4A-4B illustrate the operation of an exemplary gripper mechanism 400 having a cartridge detector 420. In particular, FIGS. 4A and 4B illustrate the interaction between proximal ends of gripper fingers 410. The proximal ends of gripper fingers 410 include or are attached to geared or toothed portions 414 that interlock and interact to rotate distal ends of gripper fingers 410 open and closed together. A motor (see, e.g., FIG. 3A) is coupled to at least one of the gripper fingers 410 to open and close the gripper fingers 410.

Gripper fingers 410 may include integrally formed portions, e.g., that are injection molded or the like, as well as multiple portions coupled together to interact during opening and closing processes. Various sized geared portions 414 are contemplated as well as various radius of curvatures depending on the particular application.

Referring now to FIG. 5, and with continued reference to FIGS. 4A and 4B, a more detailed view of a sensor subassembly 460 and cartridge detector 420 is illustrated. Cartridge detector 420 contacts a cartridge and is depressed or translated back against a spring 474 or other biasing member relative to frame 430. Frame 430 includes a small subassembly 460 attached thereto and supporting the proximal end 424 of cartridge detector 420. Subassembly 460 includes a circuit board 462, one or more optical sensors 464, fixed supports 470 for the proximal end 424 of cartridge detector 420, and spring 474 for biasing cartridge detector 420 in its extended position. An exemplary optical sensor includes a Transmissive Optical Sensor with Phototransistor Output (model TCST1030) manufactured by Vishay Intertechnology, Inc.; however, other suitable optical sensors may be used.

As the proximal end 422 contacts a cartridge and moves in a generally linear fashion relative to subassembly 460, optical sensors 464 may determine the position of a cartridge. A portion of the proximal end 424 of cartridge detector 420 may include one or more optically detectable markers, such as flange 468. Alternatively, the optically detectable markers may include flags, flanges, reflective and non-reflective elements, or the like positioned generally along a portion of cartridge detector 420. The optical detectable markers may indicate to a system or picker controller when the gripper assembly 400 is in a suitable position to close gripper finger 410 and transfer a cartridge. Further, multiple positions may be determined and used, for example, to decelerate the movement of gripper assembly 400 when approaching a cartridge to reduce the potential for damage to the gripper assembly 400 or the cartridge.

It should be recognized that other configurations and devices may be used to determine the position of a cartridge detector. For example, when the cartridge detector is depressed linearly it may cause a gear or plate having optical markers thereon to rotate and be detected by an optical sensor. Further, other sensors such as a potentiometer or linear encoder tape may be used to determine the position of a cartridge detector relative to the support structure and gripper assembly.

The above detailed description is provided to illustrate exemplary embodiments and is not intended to be limiting. It will be apparent to those skilled in the art that numerous modification and variations within the scope of the present invention are possible. Accordingly, the present invention is defined by the appended claims and should not be limited by the description herein.

1. A mechanical gripper device for transporting storage devices, comprising:
a pair of opposing gripper fingers, each having:
a proximal end pivotally mounted to a picker frame, and
a distal end adapted to engage minor side surfaces of a storage device; and
a cartridge detector extending away from the picker frame and at least partially depressible between the pair of opposing gripper fingers, wherein the distal end of the cartridge detector has a larger cross-sectional area perpendicular to the direction the cartridge detector extends than the proximal end of the cartridge detector.

2. The device of claim 1, wherein the cartridge detector includes a plunger device.

3. The device of claim 1, wherein the cartridge detector moves substantially linearly.

4. The device of claim 1, wherein the distal end of the cartridge detector extends from the picker frame a distance equal to or less than the gripper fingers.

5. The device of claim 1, wherein the distal end of the cartridge detector extends from the picker frame a distance beyond the gripper fingers.

6. The device of claim 1, wherein the distal end of the cartridge detector includes a planar surface perpendicular to the direction the cartridge detector extends.

7. The device of claim 1, wherein the distal end of the cartridge detector is removable.

8. The device of claim 1, wherein the distal end of the cartridge detector is approximately as wide as the opposing gripper fingers.

9. The device of claim 1, wherein the distal end of the cartridge detector is wider than the opposing gripper fingers.

10. The device of claim 1, further including an optical sensor configured to detect one or more optical indicia associated with the cartridge detector.

11. The device of claim 10, wherein the optical indicia are on the proximal end of the cartridge detector.

12. The device of claim 10, wherein the proximal end of the cartridge detector includes a flange element configured to be detected by the optical sensor.

13. The device of claim 1, wherein the gripper fingers are interconnected by corresponding geared portions.

14. The device of claim 1, wherein at least one of the gripper fingers includes a protrusion extending towards the other gripper finger for engaging a storage cartridge feature.

15. An assembly for detecting storage cartridges for a mechanical gripper device, comprising:

15. An assembly for detecting storage cartridges for a mechanical gripper device, comprising:
a support structure for supporting a proximal end of a cartridge detector that extends away from the support structure, wherein,
the support structure allows the cartridge detector to move in a substantially linear motion, and
a distal end of the cartridge detector has a larger cross-sectional area than the proximal end of the cartridge detector; and
a sensor configured to detect movement of a predetermined distance of the cartridge detector relative to the support structure.

16. The device of claim 15, wherein the sensor detects one or more indicia associated with the position of the cartridge detector.

17. The device of claim 15, wherein the sensor is attached to the support structure.

18. The device of claim 15, wherein the sensor includes one or more optical sensors.

19. The device of claim 15, wherein the distal end of the cartridge detector includes a planar surface perpendicular to the direction the cartridge detector extends.

20. The device of claim 15, wherein sensor includes an optical sensor and the proximal end of the cartridge detector includes a flange element configured to be detected by the optical sensor.

21. The device of claim 15, wherein the predetermined distance is associated with a cartridge position relative to the support structure.

22. An automated library system, comprising:
storage bins for housing storage cartridges;
a robotic cartridge picker mechanism;
a pair of opposing gripper fingers configured to engage a storage cartridge and mounted to the picker mechanism;
a cartridge detector extending away from the picker mechanism and at least partially depressible between the pair of opposing gripper fingers, wherein the distal end of the cartridge detector has a larger cross-sectional area perpendicular to the direction the cartridge detector extends than the proximal end of the cartridge detector.

23. The system of claim 22, wherein the distal end of the cartridge detector extends from the picker frame a distance equal to or less than the gripper fingers.

24. The system of claim 22, wherein the distal end of the cartridge detector extends from the picker frame a distance beyond the gripper fingers.

25. The system of claim 22, wherein the distal end of the cartridge detector includes a planar surface.

26. The system of claim 22, wherein the distal end of the cartridge detector is approximately as wide as the opposing gripper fingers.

27. The system of claim 22, wherein the distal end of the cartridge detector is wider than the opposing gripper fingers.

28. The system of claim 22, further including an optical sensor attached to the picker frame and configured to detect one or more optical indicia associated with the cartridge detector.

29. The system of claim 22, wherein the proximal end of the cartridge detector includes a flange element configured to be detected by the optical sensor.

30. The system of claim 22, wherein the gripper fingers are interconnected by corresponding geared portions.

31. The system of claim 22, wherein at least one of the gripper fingers includes a protrusion extending towards the other gripper finger for engaging a storage cartridge feature.

32. A method for detecting the position of a cartridge, comprising:
moving a picker mechanism towards a storage cartridge; and
sensing the position of the cartridge relative to the gripper mechanism with a cartridge detector, wherein
the cartridge detector extends away from the picker mechanism and is at least partially depressible between opposing gripper fingers of the gripper mechanism, and
the cartridge detector has a distal end having a larger cross-sectional area than a proximal end of the cartridge detector.

33. The method of claim 32, further including gripping the cartridge by the minor side surfaces.

34. The method of claim 32, wherein the distal end of the cartridge detector is approximately as wide as the opposing gripper fingers.

35. The method of claim 32, wherein the distal end of the cartridge detector is wider than the opposing gripper fingers.

36. The method of claim 32, wherein the distal end of the cartridge detector extends a distance equal to or less than the gripper fingers.

37. The method of claim 32, wherein the distal end of the cartridge detector extends a distance beyond the gripper fingers.

38. The method of claim 32, wherein the distal end of the cartridge detector includes a planar surface.

39. The method of claim 32, further including detecting one or more optical indicia associated with the cartridge detector.

40. The method of claim 32, wherein the proximal end of the cartridge detector includes one or more optical indicia configured to be detected by an optical sensor.

41. The method of claim 32, wherein the gripper fingers are interconnected by corresponding geared portions.

42. The method of claim 32, wherein at least one of the gripper fingers includes a protrusion extending towards the other gripper finger for engaging a storage cartridge feature.
